(19) United States
(12) Patent Application Publication
(10) Pub. No.: US 2021/0027261 A1
(43) Pub. Date: Jan. 28, 2021

(54) SYSTEM AND METHOD FOR OPERATING REGION-ORIGINATING DEVELOPMENT PLATFORM

(71) Applicants: Incheon Metropolitan City, Incheon (KR); KONA I CO., LTD., Seoul (KR)

(72) Inventors: Kwang Ho AN, Incheon (KR); In Pyo HONG, Bucheon-si (KR); Dong Hoon BYUN, Seoul (KR); Sang Joong KIM, Seoul (KR); Chang Yong CHOI, Seoul (KR)

(73) Assignees: Incheon Metropolitan City, Incheon (KR); KONA I CO., LTD., Seoul (KR)

(21) Appl. No.: 16/522,479

(22) Filed: Jul. 25, 2019

(51) Int. Cl. G06Q 20/04; G06Q 20/38; G06Q 20/32

(52) U.S. Cl. CPC G06Q 20/0457; G06Q 20/385; G06Q 2220/00; G06Q 20/3829; G06Q 20/3223

(57) ABSTRACT

The present inventive concept relates to a system for operating a region-originating development platform, comprising: a service server for coordinating a regional service between a physical card and a mobile terminal of a user, one or more regional member stores, and a regional integration server; and an operation management portal running on the service server, comprising a system portal part used to operate a system within the service server, a platform portal part for managing one or more merchandises offered as the regional service, and a partner portal part for managing partners including member stores, where the regional integration server comprises sub-institution servers in a layered structure to operate in conjunction with one or more base center servers at a lower level, and the mobile terminal runs a service application for providing the regional service and comprises information of at least one mobile card issued upon a request.

### FIELD OF THE DISCLOSURE

The present inventive concept relates to a system and method for operating a region-originating development platform and, in particular, proposes a system and method for operating a region-originating development platform using a prepaid card that can be linked to a user mobile terminal.

### BACKGROUND

Along with the recent widespread of smartphones, there has been a rapid advancement in PIN technology for performing online/offline payments using a mobile card stored in a smartphone instead of a plastic card.

However, such a mobile payment is possible only when the smartphone is carried by a user at all times and the smartphone stays on all the time. Hence, there are limitations in that the smartphone cannot be used as a payment method if the smartphone is somehow turned off or misplaced, or if a store does not have a mobile payment terminal (such as a barcode reader or an NFC terminal) installed.

In addition, though users familiar with smartphones would not have any issue in paying with a smartphone by executing a mobile application relevant thereto, those who are not familiar with smartphones hardly use smartphones as a payment method yet. Because of these limitations, a payment method using physical cards still accounts for a high ratio in payment transactions.

On the other hand, there have been attempts with regional service projects to revitalize local economies and help enhance the competitiveness of regional small businesses. For example, paper gift certificates have been issued for regional traditional markets, or various projects have been implemented such as providing support funds through several support projects; however, each project was carried out separately, resulting in little impact on the regional economies, and there is hardly any connection and expandability between projects.

For paper gift certificates, there exist problems in that the cost of issuing and managing the gift certificates is high, recycling them is quite difficult, and it is difficult to reissue them because verification of ownership is hardly possible when lost. In particular, there is a disadvantage of low connection and practicality of different services because gift certificates with fixed monetary values are used only once in many cases. Especially, regarding the circulation of paper gift certificates, illegal distribution of gift certificates has become a serious issue by treating them as a bearer bond. The fact that it is very difficult to control and detect illegal cash discounts (known as “kang” similar to scalping) by which distributors of paper gift certificates buy a great quantity of discounted gift certificates and rip off profits by reselling such gift certificates has been recognized as a main problem for regional gift certificates.

Moreover, since the circulation of regional gift certificates does not occur naturally, local government intervention, and thus extra cost, is necessary. Therefore, there has been a need to mitigate the inconvenience of circulating regional gift certificates and to resolve the limitations on cashing and using them.

### SUMMARY

The present inventive concept is designed to solve prior art problems related to mobile payments and regional services, and proposes a system and method for providing a region-originating development platform by linking a physical card and a mobile card.

A system for providing a region-originating development platform in accordance with an embodiment of the present inventive concept comprises: a service server for coordinating a regional service between a physical card and a mobile terminal of a user, one or more regional member stores, and a regional integration server; and an operation management portal running on the service server, comprising a system portal part used to operate a system within the service server, a platform portal part for managing one or more merchandises offered as the regional service, and a partner portal part for managing partners including member stores, where the regional integration server comprises sub-institution servers in a layered structure to operate in conjunction with one or more base center servers at a lower level, and where the mobile terminal runs a service application for providing the regional service, and comprises information of at least one mobile card issued upon a request from the user, the regional integration server, or the base center server.

Optionally, the physical card has a physical card token value different from the mobile card information, and the service server matches the mobile card information and the physical card token value with one piece of PAN information and stores them. In an embodiment, the regional integration server operates in conjunction with the one or more base center servers, and the service server may issue an electronic gift certificate usable only in a specified region in response to a request for issuing the electronic gift certificate made by the regional integration server or the base center server. When paying with the electronic gift certificate at a regional member store, the service server may determine whether to approve a payment based on balance information and region information in the service server. Upon issuing the electronic gift certificate, the service server matches and stores the regional member store and one or more pieces of merchandise information, and determines whether to approve a payment based on the merchandise information and the member store information when paying for the merchandise.

As an embodiment of the present inventive concept, a regional service may comprise a regional voucher reload process, and may further comprise a voucher reload program capable of entering a list to be reloaded for reloading a voucher; and a reload transaction terminal for connecting to the reload program through a network to receive the list to be reloaded. In this case, the network may be a local network to which the connection from external networks is blocked. The reload transaction terminal comprises a security authentication module (SAM) for storing an encryption key, and the SAM may encrypt a message authentication code using the encryption key. The reload transaction terminal may generate a reload transaction statement using the received list to be reloaded, and may generate an encrypted reload transaction statement by adding the encrypted message authentication code thereto after the generation of the reload transaction statement. The service server may receive the encrypted reload transaction statement to decrypt the message authentication code, verify the validity of the reload transaction statement, and perform reloading to the voucher if the validity is verified.

As an alternative embodiment, the service server may issue an ID card upon a request by the regional integration server to the mobile terminal or the physical card, and the ID card may comprise ID information and access authorization information. Further, on the physical card or the mobile terminal of the user, personal information including health information may be recorded through an institution server, and the recorded personal information may be checked through an authenticated terminal. The output screen of a service application comprises an advertisement area and a member store information area, and the member store information area may comprise a contact section for making a phone call. Moreover, an order information send part for sending transaction information or cancellation information to a member store terminal may be included.

A further alternative embodiment of the present inventive concept presents a method for operating a region-originating development platform, by a service server which coordinates a regional service between a physical card and a mobile terminal of a user, one or more regional member stores, and a regional integration server, comprising: issuing a mobile card in a form of a token value, based on a request from a mobile terminal of a user or the regional integration server; by the service serve, matching and storing the token value with PAN information which is a card number of the physical card; and receiving and storing the token value as mobile card information. Here, the regional integration server comprises sub-institution servers in a layered structure to operate in conjunction with one or more base center servers at a lower level, and the storing may comprise storing by the mobile terminal through a service application for providing the regional service and storing at least one piece of mobile card information issued in response to a request from the user, the regional integration server, or the sub-institution server.

The method may further comprise: by the regional integration server, storing design information of the regional service and electronic gift certificate information including types and issue information of an electronic gift certificate usable in a region, and requesting to the service server for issuing the electronic gift certificate based on the electronic gift certificate information; by the base center server, designing a base center electronic gift certificate based on the electronic gift certificate information provided by the regional integration server, and redesigning the base center electronic gift certificate by adding thereto an additional condition provided by a base center service design part; and issuing the base center electronic gift certificate by the service server in response to a request from the base center server. In addition, other methods having the same technical features as the optional features that can be implemented in the system described above may be carried out as well.

According to a region-originating development platform of the present inventive concept, it is possible to store a regional gift certificate, a voucher, support funds, etc., such as gift certificates usable in a region or in specified markets or areas of the region in a physical card and a mobile card as a unified payment method, thereby providing an effect of maximizing convenience for users. It is easy to accurately calculate balances and collect statistical data and to use them as materials for various regional economic analyses by integrating systems through the service server. The payment technique of the present inventive concept is based on a payment standard (EMV) so that member stores or organizations can make use of the infrastructure of existing payment terminals, thereby saving the cost to build a new business, as well as it has an effect of boosting consumption within a region by limiting the availability of the payment service to regional member stores. It may be easy for the member stores to circulate their own gift certificates, points/mileages, etc., and to boost sales with increased spending within the region and to improve competitiveness of small businesses thanks to the reduction in various fees or charges. Accordingly, it is possible to maximize the economic profits for member store owners, and to contribute to promoting broad acceptance of electronic transaction services.

Moreover, in case the regional integration server provides a local service in conjunction with a basic-level local government center within a region, maintenance may be easy because of a unified service format, as well as since base centers use an integrated platform without needing to spend extra investment expenses to individually build a region-originating development platform, cost reduction in new service construction may be achieved, thereby enhancing an economic effect. This has an advantage of being applicable not only to basic-level local governments under a metropolitan government but also to the system of private organizations that have been operating paper gift certificates within the region.

The present inventive concept has an effect of implementing a payment service by using prepaid electronic cards without the intervention of a payment gateway (PG) or a value added network (VAN), unlike conventional online payment systems. In this way, there will be greater opportunities to save a large amount of transactions fees, without requiring the services by the PG or VAN.

According to the electronic gift certificate service of the present inventive concept, it is possible to increase the amount of money available within a region by mobilizing human and material resources through electronic gift certificates, and it may allow for the electronic gift certificates to be circulated within the region so to help regional residents generate economic profits. In addition, new transaction networks may be provided for exchanging goods and services through the region-originating development platform so as to support the creation of new markets, thereby enhancing networking among regional residents. Moreover, it is possible to replace the goods and services that have been imported from the outside with the goods and services produced regionally, and to create new regional markets using electronic gift certificates and new jobs through trading activities. Furthermore, it is possible to re-assess the values of economic activities that have been undervalued without proper market values previously and to exchange such economic activities, thereby enabling the reevaluation of previously undervalued economic activities.

Further, in case of implementing a voucher reload process by the region-originating development platform of the present inventive concept, it is possible to automatically add support funds (allowances) online by a government office to a card belonging to a user without visiting the government office in person, thereby greatly improving convenience for users. In addition, unlike traditional credit cards, it has an advantage of easy acquisition of a card used for receiving support funds, without strict requirements and complicated approval or authentication processes as in credit card applications. Moreover, there is an advantage for government offices or institutions providing support funds to directly reload such cards or to calculate and manage balances without going through various financial institutions or related companies, thereby facilitating management or statistical analysis and saving expenses spent on various project implementations.

Furthermore, the region-originating development platform of the present inventive concept has an advantage of an unlimited expandability of the service through connection to various regional member stores, individuals, and institutions. While implementing such various services, a mobile terminal and a physical card are supported as a single platform and a unified means, leading to integration and connection of regional services, and resulting synergy effects and reduction in expenses can have a significant impact on revitalizing regional economies and securing competitiveness of member stores.

### BRIEF DESCRIPTION OF THE DRAWINGS

FIG. 1A is block diagram of a system according to an embodiment of the present inventive concept;

FIG. 1B illustrates in detail a regional integration server of a system according to an embodiment of the present inventive concept;

FIG. 2 is a block diagram illustrating the relationship between a regional integration server and base centers according to an embodiment of the present inventive concept;

FIG. 3 is a block diagram for describing an electronic gift certificate service according to an embodiment of the present inventive concept;

FIG. 4 is a block diagram showing a region-originating development platform according to an embodiment of the present inventive concept;

FIG. 5 is a block diagram illustrating a payment process of a system according to an embodiment of the present inventive concept;

FIG. 6 is a block diagram for describing a voucher reload process of a system according to an embodiment of the present inventive concept;

FIG. 7 is a flow diagram for describing a voucher reload process of a system according to an embodiment of the present inventive concept;

FIG. 8 is a block diagram for describing institution services of a system according to an embodiment of the present inventive concept;

FIG. 9 is an exemplary drawing for illustrating a synchronized operation between a user terminal and a physical card according to an embodiment of the present inventive concept;

FIG. 10 is an exemplary drawing for describing an ID function, an advertisement function, and an order function of a user terminal according to another embodiment of the present inventive concept;

FIG. 11 is a drawing for describing social responsibilities and a virtuous cycle structure of a regional community for a system of the present inventive concept.

Like reference numerals indicate like members in various drawings.

### DETAILED DESCRIPTION OF THE PREFERRED EMBODIMENTS

A specific structural or functional description with respect to embodiments according to the present inventive concept disclosed herein is provided merely for describing embodiments according to the concepts of the present inventive concept, and such embodiments according to the concepts of the present inventive concept may be implemented in various forms and is not limited to the embodiments described herein.

Since embodiments in accordance with the concepts of the present inventive concept are capable of various changes and forms, embodiments will be illustrated in the accompanying drawings and will be described in detail below. However, it is not intended to limit embodiments according to the concepts of the present inventive concept to specific embodiments disclosed herein, and to cover any changes, equivalents, or replacements within the spirit and technical scope of the present inventive concept.

The terms “first” or “second” used herein describe various components, but it should be understood that such components are not intended to be limited by such terms. These terms are used only to distinguish one component from another, and thus, for example, a first component may be referred to as a second component or vise versa, without departing from the protective scope of the concept of the present inventive concept

When described as one component being “coupled” or “connected” to another components, it should be understood that one such component may be directly coupled or connected to another component, but it is also possible to have a further component therebetween. On the other hand, when described as one component being “directly coupled” or “directly connected” to another component, it should be understood that there is no other component therebetween. The same applies to the phrases describing relationships between components, such as “between,” “directly between,” “adjacent,” “directly adjacent,” etc.

The terms used herein are merely to describe specific embodiments, and are not intended to limit the present inventive concept. Singular forms used herein may include plural forms as well, unless otherwise explicitly indicated in the context. The terms “comprise” or “have” used herein are intended to indicate the existence of features, numbers, steps, operations, components, parts, or combinations thereof described herein. Therefore, it should be understood that such terms do not preclude the possibility of the existence or addition of one or more further features, numbers, steps, operations, components, parts, or combinations thereof

Unless otherwise defined, all the terms including technical or scientific terms used herein represent the same meaning understood generally by a person having an ordinary skill in the art to which the present inventive concept pertains. The terms as defined in dictionaries used commonly are construed to have the meaning consistent with the context of relevant technology and accordingly, are not construed ideally or overly formally, unless otherwise clearly defined herein.

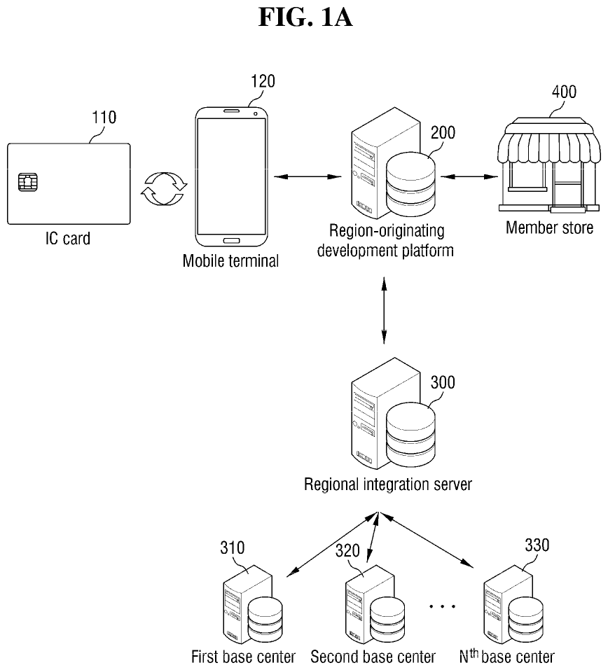

FIG. 1A is a block diagram illustrating a system 100 according to an embodiment of the present inventive concept. The system 100 comprises a mobile terminal 120 and a physical card 110 used by a user, a region-originating development platform 200, a regional integration server 300, and a regional member store 400. The system 100 is not limited to what is described, and may operate in conjunction with financial institutions, the PG, the VAN, etc., required for reloading, issuance, or payment of cards, though not shown in the drawing.

The mobile terminal 120 according to the present inventive concept is an electronic device carried by a user, and may be a device having a communication function for linking with the physical card. For example, the electronic device may comprise at least one of a smartphone, a table computer, a mobile phone, a video phone, an eBook reader, a desktop computer, a laptop computer, a netbook computer, a personal digital assistant (PDA), a portable multimedia player (PMP), an MP3 player, mobile medical equipment, a camera, or a wearable device (for example, a head-mounted device such as electronic glasses, clothes, bracelets, necklaces, accessories, and tattoos, or a smartwatch).

The electronic device according to the present inventive concept may be a combination of one or more of the devices described above. The electronic device of the present inventive concept may be a flexible device. In addition, it is obvious to a person having an ordinary skill in the art that the electronic device of the present inventive concept is not limited to the devices described above.

The physical card 110 may be implemented in the form of a physical card (for example, in the form of a rectangular plastic card) having a payment module built therein for performing a payment and a communication function capable of communicating with the mobile terminal 120. As an embodiment, the physical card 110 may be implemented in the form of a contact and/or contactless card, such as an IC card, a combi card, etc. The IC card and combi card are a type of card for storing card information in the form of applets on an IC chip. The physical card 110 may be implemented in the form of a smart card for storing a large amount of information by having an IC (integrated circuit) storage device built therein, may have one or more ICs built thereon, and may be different cards used for such as financial institutions, medical insurance cards, transportation cards, credit cards, USIMs, etc.

In an embodiment, the physical card 110 may be registered using a service application run by the mobile terminal 120 and manage the transaction details thereof. For example, it is possible to directly enter the card information or recognize the card information by taking a picture of a barcode on the physical card 110 using the mobile terminal 120, and to register a mobile card corresponding to the physical card 110 to the service application. In addition to barcodes or QR codes, the mobile terminal 120 and the physical card 110 may be paired or linked to each other via near field communications (such as, NFC). In an embodiment, the mobile terminal 120 or the physical card 110 of the user may provide a payment method using NFC (near-field communication) or a barcode or QR code as well as an IC chip, and may also comprise various contact or contactless (for a combi card) payment functions, etc.

In an embodiment, when using the service application, the user can join a membership without face-to-face confirmation and can authenticate his or her identity so as to register a real-name account, and accordingly, can be provided with a regional service presented in the present inventive concept without visiting institutions in person. In another embodiment, the service application may be implemented to be registered not only with a real-name account but with a virtual account, or to be compatible with points offered by other financial institutions or organizations.

A region-originating development platform 200 is a service platform based on host card emulation (HCE), and supports issuance, payments, and operations of monetary notes (such as electronic gift certificate) to be circulated within a region, and may be implemented for provision of vouchers based on support projects and a function for managing personal information such as a student ID, health information, etc. The region-originating development platform 200 may comprise a service server 220 for implementing various regional services, an operation management portal 210 for managing and operating in a web environment, a voucher reload program 230, and a reload transaction terminal 240. The region-originating development platform 200 is a service platform based on host card emulation (HCE), and is implemented to store and manage personal information such as card information in a service server that performs a cloud platform function, instead of storing the personal information in a hardware SE such as a UICC (universal integrated circuit board) and an embedded secure element (SE). The cloud system refers to a card information storage system for receiving, from the outside, a card requested to be issued from the user of the mobile terminal and storing it in the SE which is a safe storage, and manages the life cycle by regularly updating it with the latest information. In order to solve the security issue on implementing such HCE technology, the present inventive concept adopts tokenization, and issues a token corresponding to card information so as to prevent personal information or card information from being leaked during transactions.

In an embodiment of the present inventive concept, the region-originating development platform 200 may introduce electronic gift certificates in an electronic form instead of conventional regional gift certificates in paper type, and manage them to be widely used in transactions. The region-originating development platform 200 may issue and manage the electronic gift certificates, and may communicate transaction data with a member store 400 through a member store terminal during the transaction by a user. In this case, the member store terminal comprises both a conventional payment terminal and a dedicated terminal for the regional services of the present inventive concept. The member store 400 may have a payment terminal such as POS or CAT terminal, and perform payments of the electronic gift certificates using the physical card 110 or the mobile terminal 120. In this case, the electronic gift certificates may comprise support funds in the form of a voucher of regional support projects, regional gift certificates usable only in corresponding city or county areas or specified markets, etc. Upon payment at the member store 400, the region-originating development platform 200 may check the balance of the electronic gift certificate, and determine whether to approve the transaction by further checking information such as payability in the regional information. Later on, the region-originating development platform 200 may calculate the balance via the regional integration server 300 operated by local government offices or other financial institutions.

The regional integration server 300 may provide data as required to support various regional services running on the region-originating development platform 200. In an embodiment, the regional integration server may comprise a database or server operated by government offices of a corresponding region, and may be implemented to be accessible by authenticated users (for example, government officials of that region). In addition, the regional integration server 300 may receive non-data such as statistical materials, calculation materials, analysis materials, etc. related to various regional services provided by the region-originating development platform 200. Moreover, the regional integration server 300 may operate in conjunction with a hierarchical structure of base centers 310-330, and autonomous centers one on top of another in multi-layers at sub-levels.

In addition, the region-originating development platform may support P2P (peer-to-peer) transactions based on blockchain technology. In an embodiment, the region-originating development platform supports to enable P2P transactions between owners of member stores and users. For example, during payments at a member store without member store terminals installed therein, transmission and reception of an amount of payment may be made possible for the transaction between the mobile terminal of the member store owner and the mobile terminal of the user, thereby supporting a transaction between personal terminals using the service application. Furthermore, since such transactions between individuals are provided based on the blockchain technology, it is possible to improve the transparency of transactions, to enhance security, and to reduce cost for operation and management.

In this way, the region-originating development platform of the present inventive concept acts as a platform capable of providing various services in conjunction with a large number of member stores 400 operated by small businesses within a region and a regional integration server 300 operated by a regional government office, and provides a means for boosting the regional consumption while utilizing existing infrastructures by using physical cards with which users are familiar. Moreover, safe recording and storage of sensitive personal information such as ID information, health information, etc. is made possible by utilizing the security nature of an IC card, while it is implemented to be retrievable as necessary, so as to provide an effect of maximize convenience for users. Furthermore, in accordance with the region-originating development platform proposed by the present inventive concept, it is possible to implement revitalization of regional economies, integration and simplification of services, as well as to provide an effect of reducing project expenses.

FIG. 1B illustrates in detail a regional integration server 300 in a system according to an embodiment of the present inventive concept. The regional integration server 300 may comprise one or more base centers 310 to 330, or the regional integration server 300 may be implemented to operate in conjunction with the base centers 310 to 330. Though not shown in the drawing, as described above, the regional integration server 300 may comprise one or more base centers 310 to 330 at a lower level, and respective base centers may comprise one of more autonomous centers, so that regional government offices may be implemented as a hierarchical structure. For example, in the case that the regional integration server is a server run by a city government, the base centers may be a district server of a district government under the corresponding city. In this way, since the regional integration server 300 controls a number of base centers 310 to 330 at a lower level, it is possible to provide regional services so as to issue, pay, and manage gift certificates or monetary notes distributed individually by the base centers 310 to 330, in addition to regional combined gift certificates through the region-originating development platform 200 provided by the present inventive concept. As the region-originating development platform 200 issues electronic gift certificates with its usability limited to a specified region and provides a transaction system, it may promote transactions within a particular region, so as to achieve the effect of boosting consumption in the region. Such regional electronic gift certificates may be limited to be usable only in the administrative district of the regional integration server 300 or the base centers 310 to 330, or may limit its region (for example, a specified district, blocks or specified markets, buildings, etc.) to be used depending on the design of merchandises

In an embodiment, the regional integration server 300 may assign an individual identification code to each of the electronic gift certificates issued by the base centers. For example, when a first base center 310 issues an electronic gift certificate, the regional integration server 300 may assign an identification code of 1001 to the electronic gift certificate to be included in a token value, so as to be used as an ID or a control number. In an embodiment, if a server of the first base center 310 issues an electronic gift certificate, a request for issuing an electronic gift certificate may be made to the service server 220 by the operation management server 210 or the client program 270, and the issuance, sales, payments, calculation of balance, etc. of the electronic gift certificate may be managed by the service server 220. For example, during balance calculation, the amount paid at the member store 400 may be calculated via the service server, and balance calculation data may also be exchanged in a predetermined cycle between the base center and the service server 220.

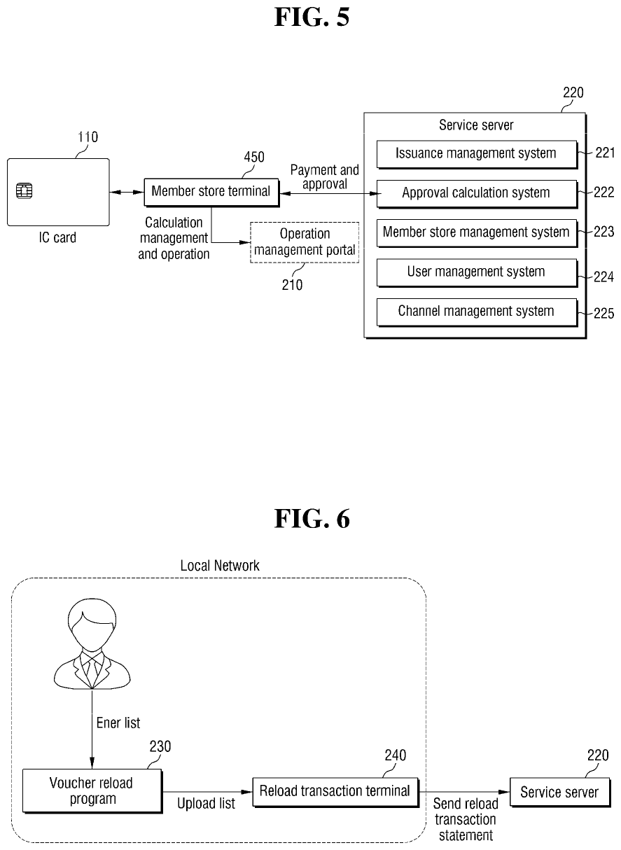

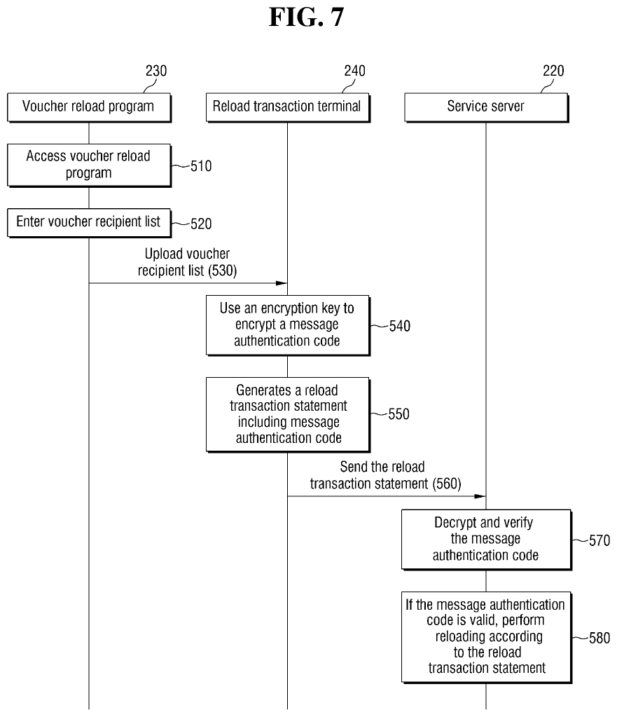

In a further embodiment, in case of performing voucher reload process, the first base center 310 may use the client program 270 provided to a computing device of a person in charge to enter a list to be reloaded, and create and send a reload transaction statement to the service server 220. The service server 220 may reload to a user according to the received reload transaction statement. The voucher reload process will be described below in detail with reference to FIGS. 6 and 7.

As such, in the case that the regional integration server 300 performs a regional service in conjunction with the corresponding base center, maintenance as well as collection of statistical data by regions for analysis may be easy because of an integrated service format. In addition, since base centers use a unified platform without needing to spend extra investment expenses to individually build a region-originating development platform, cost reduction in service construction may be achieved, thereby enhancing an economic effect.

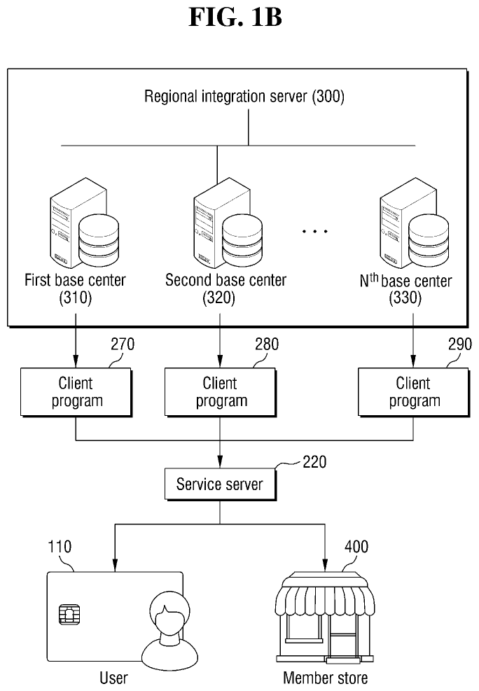

FIG. 2 is a block diagram illustrating the relationship between the regional integration server and base centers according to an embodiment of the present inventive concept. As described with respect to FIG. 1B, the regional integration server may operate in conjunction with one or more base centers 310 to 330. In this case, the base servers may be various institutional servers located within an administrative district covered by the regional integration server. For example, if the regional integration server 300 is operated by Incheon City, Republic of Korea, then the first base center 310 would be a server at Yeonsu-gu base center, the second base center 320 would be a server at Namdong-gu base center. In addition, each base center may comprise one or more autonomous centers, and accordingly, the servers at a regional government office may be implemented in a hierarchical structure. In an embodiment, the first base center 310 may comprise a la autonomous center 314, a 1b autonomous center 315, . . . , and a In autonomous center 316 at a lower level, or may operate in conjunction with them. Such base centers or autonomous centers may comprise various affiliated institutions such as Education Office, welfare centers, etc.

The regional integration server 300 may comprise: a combined service design unit 301 for designing various regional services proposed in the present inventive concept and for storing designed goods or services; an electronic gift certificate management unit 302 for managing types and accounts of electronic gift certificates; and a base center management unit 303 for managing the base centers.

In an embodiment, the regional integration server 300 may store the types, usage procedure, etc. of various regional services. The regional integration server 300 may store services designed by itself, or may store services designed by the individual base centers 310 to 330. For example, the regional integration server 300 may store the services designed by itself as regional combined services or common services, and store the services designed by the individual base centers as base center services or regional customized services. The regional integration server 300 may store one or more services by operation servers, by regions, or by time, and users or base centers may check the services. For example, if the regional integration server 300 stores new services every month and upload them onto the region-originating development platform 200, users may search or check the uploaded services through the service application on the mobile terminal 120.

The electronic gift certificate management unit 302 stores and manages the information of the electronic gift certificates designed by the regional integration server 300 or the base centers 310 to 330. In an embodiment, the electronic gift certificate management unit 302 may store the information of the electronic gift certificate issued by the regional integration server 300 such as types, valid periods, usable areas, usable time slots, etc., and may also store deal information and terms and conditions for special events, discounts, or points, etc. related to the electronic gift certificate together. In a further embodiment, the electronic gift certificate management unit 302 may also store the information of the electronic gift certificates provided by each of the base centers.

The base center management unit 303 manages the base centers 310 to 330 which provide and operate the regional services in order to effectively manage such services. In an embodiment, the base center management unit 303 may store the information of the base centers which provide the region-originating development platform 200 in the form of number or character codes, and may also store operating services at a lower level together. Authorization may be set individually for the regional services accessible or retrievable by the base center management unit 303.

The base centers 310 to 330 may comprise a base center service design unit 311, an electronic gift certificate management unit 312, and a voucher management unit 313. Such units are components for describing the regional services of the present inventive concept, and are not limited to the units described and may further comprise various components for operating the base centers. The base centers may comprise one or more base centers as shown in FIG. 2. Though a first base center 310, a second base center 320, . . . an N^{th} base center 330 are illustrated in parallel, the base centers may comprise names of respective institutions and comprise sub-institution servers at a lower level of respective base centers. Further, two or more base centers 310, 320 may operate in conjunction with each other, or operate in a combined form, partially or entirely. Moreover, though not shown in the drawing, respective autonomous centers 314, 315, 316, 324, 325, 326, 334, 33, 336 may individually comprise such components as an autonomous center service design unit, an electronic gift certificate management unit and/or a voucher management unit.

The base center service design unit 311 may store the types and usage procedure, etc. of the various regional services, as is the case with the regional integration server 300 described above. In an embodiment, the base center service design unit 311 may design some conditions in common with the regional services operated by the regional integration server 300, but detailed conditions may be designed individually. For example, for a regional combined gift certificate issued by the regional integration server 300, if it is configured to be used in a “city-level” area with a discount rate of 5%-10% at an initial sale, the base center service design unit 311 may store design conditions by designing such that the regional combined gift certificate may be used in a “Gu”-level area assigned by the base center with a discount rate of 10% at an initial sale. In addition, the base center service may modify and use the names of the services designed by the regional integration server 300 to be fit with the base center services, or may add further terms and conditions. For example, it may be possible for the base center 310 to change only the name of Incheon City gift certificate of the regional integration server 300 to Yeonsu-gu gift certificate, and may redesign it by adding more deal information such as 10% discount on Wednesdays every week, etc.

As such, in case the base center 310 modifies in part the services provided by the regional integration server 300, there is an advantage in that the base center may provide a customized service without an additional design cost. Further, if such services designed in a single platform and in a hierarchical structure are used, compatibility may be ensured and maintenance of the services may be efficient, thereby securing the continuity of the services. Moreover, though there was a high cost in introducing and running regional services by individual institutions, it is possible to design regional services such that efficient budget management can be ensured without such extra spending and more benefits can be returned to regional residents.

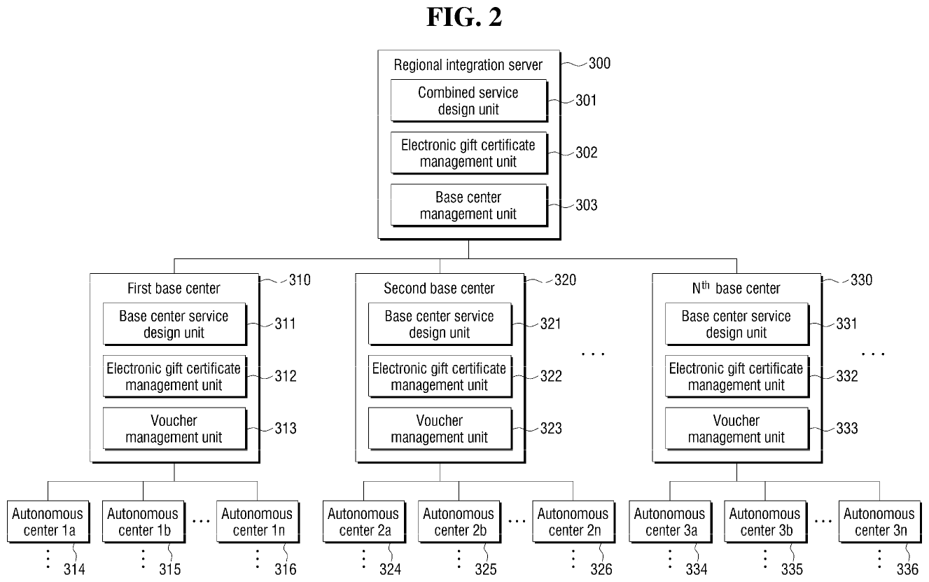

FIG. 3 is a block diagram for describing an electronic gift certificate service according to an embodiment of the present inventive concept. Of the services using the region-originating development platform 200 proposed by the present inventive concept, an electronic gift certificate service will be described below. The electronic gift certificate service proposed by the present inventive concept refers to an electronic gift certificate that may be implemented in a form to be stored in the mobile terminal 120 or the physical card 110 so as to be usable within a specified region or a community, and may be issued by the region-originating development platform 200 according to the design by the regional integration server or the base centers within a region.

Since such a regional electronic gift certificate may be used as a medium to be circulated or exchanged for merchandises as legal tender within a specified region or a community, it can revitalize local businesses and mom and pop stores through regional economic growth and can also prevent regional funds from flowing out of the region and help establish self-support bases for low and middle income families. In addition, it is also possible to provide electronic gift certificates for various allowances given to regional residents and customized welfare points offered to local government officials, and accordingly, the problems inherent in existing paper gift certificates may be resolved and it may become a means to encourage regional economic growth.

The electronic gift certificate service may be provided to the users 350, 360 and member stores 400 of small business within the region via the regional integration server 300, base centers 310, and region-originating development platform 200. In the present embodiment, though the electronic gift certificate operated by the first base center 310 is used as an example, the inventive concept is not limited thereto, and it may also possible to provide electronic gift certificates operated by various institutions within the regions, such as the regional integration server 300 and second base center 320, N^{th} base center 330, etc.

As describe with reference to FIG. 2, the regional integration server 300 may provide the electronic gift certificate service, the first base center 310 may apply a customized design to the electronic gift certificate service to be appropriate thereto so as to design a unique electronic gift certificate to the first base center. In an embodiment, when the design information of the base center 310 is completed, an issuance request may be sent to the region-originating development platform 200, and then the r region-originating development platform 200 may issue an electronic gift certificate according to the design information.

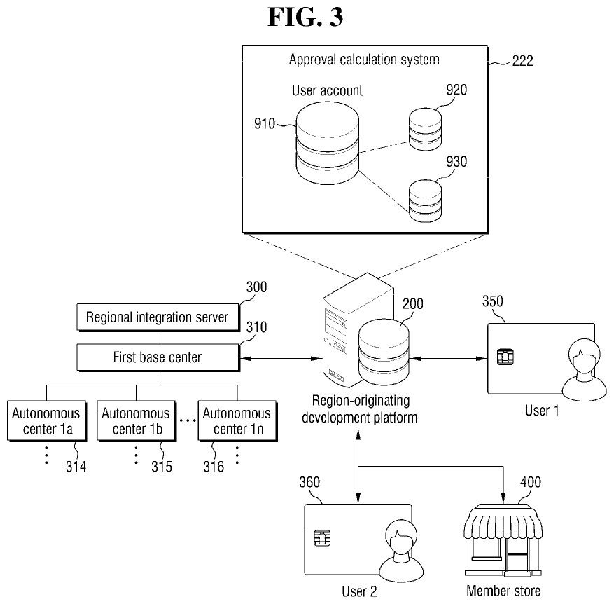

The region-originating development platform 200 may comprise a service server 220 for providing a regional service, and the service server 220 may comprise an approval calculation system 222 (see FIG. 4). In this case, the approval calculation system 222 may match various types of electronic gift certificates with a user account and store in a ledge server. In an embodiment, the approval calculation system 222 may comprise a storage unit 910 for user account information or card information, and a storage unit 920 for electronic gift certificates of various types, and may match respective electronic gift certificates with user accounts and store the balance information thereof.

In an embodiment, the electronic gift certificate may be issued with a token value as an identifier, and the service server may match one or more electronic gift certificate account with a user account and store them together. The electronic gift certificate may be issued with different token values for the mobile terminal 120 and the physical card 110, respectively, and the token values may be stored after matching with one gift certificate number. By using this method, the electronic gift certificate in the form of the physical card and the mobile card may be used like a single gift certificate, without a separate synchronization process, and the balance may also be readily managed by the server side.

The region-originating development platform 200 may provide and operate various electronic gift certificates described above. In an embodiment, the region-originating development platform 200 may comprise one or more predetermined exchange algorithms, and may store the electronic gift certificates 920 issued by the regional integration server 300, the electronic gift certificates 930 issued by the base centers, etc. In addition, the electronic gift certificate has an advantage of easy tracking and quick exchange for money flow on accounts, and accordingly, may support for exchange or combination between electronic gift certificates. In an embodiment, it may be implemented such that balance combination or money exchange can be possible between the electronic gift certificate 920 of the regional integration server and the electronic gift certificate 930 of the base center. Though the present embodiment mainly describes a case where the electronic gift certificates 920, 930 have the same monetary unit (for example, Korean Won) as legal tender, combination or exchange (currency exchange) may be supported between electronic gift certificates 920, 930 through a predetermined exchange algorithm if respective gift certificates have different monetary units or values. For example, in case a firs user 350 who is a resident of a region covered by the first base center 310 uses an electronic gift certificate 920 provided by the base center 310, the electronic gift certificate 920 may be deposited in the user account (or an account number) through the service application on the mobile terminal 120. In other words, it may be stored in an electronic gift certificate 920 account such as a ledger server in the form of recording the remaining balance thereon. Such an electronic gift certificate 920 may be implemented to be paid at member stores 400 within the region, or to be given as a gift to a resident of different regions or to be exchanged.

In a further embodiment, the electronic gift certificate or the electronic gift certificate of the base center may be implemented to allow for exchange or combination according to a predetermined rate with gift certificate issued by other institutions or other institutional payment means including points. In addition, mobile card information which is a prepaid electronic payment means may be implemented to be reloaded with other institutional payment means as a reload means through the service server.

Moreover, the region-originating development platform 200 of the present inventive concept makes it possible to design various goods. Conventional credit cards have a drawback in that goods or services are hard to modify once designed. However, for the prepaid payment means such as the electronic gift certificates provided by the region-originating development platform 200, it is easy to change discount rates and who bears the burden of discounts, and it is possible to design and modify various goods such as addition and removal of applicable member stores, thereby making it possible to design customized goods by time, by regions, and by institutions. For example, the electronic gift certificates provided by the regional integration server 300 may get a discount of 5% in member stores within entire areas of the city, and may be designed such that the city government bears the burden of discount amounts. Also, the base center 310 may be able to modify the applicable benefits such that a discount of 5% may be applied in member stores within entire areas of the city and 10% discount may be applied in member stores within a region covered by base center, and both the base center and operator share the burden of the additional benefits, thereby making it possible to design in various ways.

In an embodiment, the electronic gift certificate may be set to be deposited within a region and to be consumed within the region. As described above, by supporting various types of electronic gift certificates as a means of transaction in various regions, voluntary use of the electronic gift certificate may be encouraged.

In a further embodiment, the electronic gift certificates may be accumulated by users 350, 360 so as to raise funds for the region. For example, users may provide labor or service to make an hourly wage and may store them in the form of the electronic gift certificate, and may pay part or entirety of it to raise funds for the region or pay as fees. In other words, expenses incurred within a region may be directed back to regional services to form a circulation structure, so that users may contribute to the society directly or indirectly and also receive tax benefits for donations, and that all members within region including institutions and users may be benefited.

Furthermore, in conjunction with a voucher service describe below, various allowances or support funds provided as a voucher may also be provided as an electronic gift certificate. For example, for a child with developmental disability, a medical support fund may not be provided to a real account with cash money, but be provided to the user 350 account in a manner of reloading a voucher via the region-originating development platform 200.

According to such an electronic gift certificate service, it is possible to increase the amount of money available within a region by converting human and material resources into electronic gift certificates by processing them as expenses such as salaries, and it may allow for the electronic gift certificates to be circulated within the region so as to help regional residents generate economic profits. In addition, new transaction networks may be provided for exchanging goods and services through the region-originating development platform 200 so to support the creation of markets, thereby enhancing networking among regional residents. Moreover, it is possible to replace the goods and services that have been imported from the outside with the goods and services produced regionally, and to create new regional markets using electronic gift certificates and new jobs through trading activities. Furthermore, it is possible to re-assess the values of economic activities that have been undervalued previously without proper market values and to exchange such economic activities, thereby enabling the reevaluation of previously undervalued economic activities.

According to such regional services, it is possible to implement a voluntary virtuous circle of regional economic activities and social expenses, and accordingly to realize regional sharing economy with an effect of following and promoting international standards such ISO-26000 (International Standard for guidance on social responsibility) which requires efforts to help communities such as community contribution and utilization of public goods.

FIG. 4 is a block diagram showing a region-originating development platform 200 according to an embodiment of the present inventive concept. The region-originating development platform 200 may comprise such components as the service server 220, the operation management portal 210, the voucher reload program 230, and reload transaction terminal, as described above. However, the present inventive concept is not limited to those described, but may further comprise another system or service platform for implementing the region-originating development platform 200, a database, input/output device, communications device, etc.

The service server 220 may comprise an issuance management system 221 for issuing and managing cards, an approval calculation system 222 for approving transactions and managing a ledger, a member store management system 223 for managing member store information, a user management system 224 for managing user information, and a channel management system 225 for managing external channels such a supplementary service, etc. Though these components are illustrated as separate units 221 to 225, it may be possible to operate in a combination of two or more components, or may be implemented by dividing the systems into various functions.

The issuance management system 221 may issue a card in response to a card issuance request received from the mobile terminal 120. In case that the issuance management system 221 receives a card issuance request through a service application installed on the mobile terminal 120 or on a separate website (for example, operation management portal 210), it may process to approve the issuance of the card if preset conditions (such as credit requirements) are met. For example, issuance management system 221 may request for creation of a token value to the Token Service Provider (TSP).

Here, the TSP issues a token value corresponding to Primary Account Number (PAN) information (card information) for the card issuance request. The TSP may map the issued token value and the PAN information to store them in the form of a table. In another embodiment, the TSP server may be implemented to store and use a predetermined algorithm that may infer a value between the token value and the PAN information, or to store only the path to the mapping table of the token value and the PAN value.

The issuance management system 221 may receive a token value corresponding to the issued card from the TSP, an may forward it to the mobile terminal 120 so to record the card information. The card information may be issued in the form of a token value and issued to the mobile terminal 120 in the form of an HCE card. The HCE card is a card capable of cad emulation with the function of the HCE of the mobile terminal 120 without a physical SE, and may be stored in the form of a token value. During the transaction using the mobile terminal 120, a user forwards the token value to a member store payment terminal 400 and carry out a transaction through the service server 220.

In another embodiment, in order to issue a physical card 110, a card issuance system for issuing a physical card may be used separately, in addition to the service server 220. The card issuance system may issue a new card with a record of a token value, a transportation function, or an amount (for example, a fixed amount) into the physical card. Upon issuing the physical card, the token value and card information may be stored in the service server 220 or stored and managed separately. The card issuance system is a server different from the TSM server, and refers to a server used to physically issue a physical card.

In an embodiment of the present inventive concept, because the mobile card and the physical card 110 are linked to each other for use, it is possible to map and manage the token value of the physical card to the mobile card, without using the TSM server which separately manage the SE of the physical card.

Moreover, the physical card 110 of the present inventive concept may be implemented to be linked to at least one HCE card issued to the mobile terminal 120. The physical card 110 may also have a unique token value at the time of issuance, as is the case with the HCE card.

The approval calculation system 222 is a system for processing whether to approve a transaction for a payment request and for calculating a balance, and may comprise a ledger management server for managing reloaded amounts, balances, etc. The ledger management server manages the reloaded amount and the balance after transaction corresponding to the account or the PAN information registered at the time of joining to the service application by the mobile terminal. For example, at the time of a transaction request from the member store payment terminal 400, the approval calculation system 222 may check the balance corresponding to the PAN information included in the transaction request via the ledger management server, and may approve the payment if the amount of the payment is within the balance. In this case, the transaction request may contain a token value, and the ledger management server may acquire the PAN information corresponding to the token value through the TSP and determine whether to approve the payment. In an embodiment, the service server 220 may provide such functions as automatic reloading, reloading through a virtual account, adding points, etc., and may support to be reloadable in various ways according to the settings of a user.

In an embodiment, the approval calculation system 222 may newly create the information of an issued card, at the time of issuance, and store initial balance information. For example, the mobile card may have an initial balance of [symbol] 0, but the balance becomes a certain amount after reloading and the reloaded amount may be stored in the ledger management server. For a physical card, if the card is of a fixed monetary value, the corresponding amount may be stored in the ledge management server at the time of card issuance, and if the card is reloadable, the balance of [symbol] 0 may be recorded. For another example, a physical card may be implemented to store the card information and account information together in the ledger management server at the time of the registration of the physical card 120 to the service application by the user through the mobile terminal 120.

The approval calculation system 222 may approve a transaction in conjunction with other verification authorities if a verification is needed for the transaction at the time of approving the transaction, in addition to the member store 400 which has made an approval request. For another example, if a physical card 110 corresponding to a regional gift certificate (monetary note) usable only in a specified region is used, the remaining balance along with region information may be checked first at the time of card transaction before processing the approval of the transaction.

The approval calculation system 222 may carry out balance calculation periodically in a predetermined period, and may be implemented to transfer funds for payments to member stores.

The member store management system 223 is a system for managing member stores within a specified region or member stores which have issued gift certificates or monetary notes for a specified region, and may comprise a database for storing member store IDs and details of the member stores. In an embodiment, the member store management system 223 may store details of the member stores such as member store addresses, phone numbers, zip codes, etc. corresponding to merchant IDs consisting of numerals and characters. For example, at the time of an inquiry request for region information using a merchant ID from the approval calculation system 222, it is possible to check the zip code for the merchant ID to verify whether it is a member store in the corresponding region or not.

The user management system 224 may comprise regional residents as users who have registered their physical cards through the service application and use the services. User information such as user account IDs, phone numbers, terminal information, etc. may be stored, and may also be stored in conjunction with the card information (for example, token numbers) registered by the users.

A channel management system 225 is a system for managing connections with external channels when linked to external services or external servers for payment processing, payment information, or supplementary services, and may be connected to various external systems to provide different regional services. For example, the channel management system 225 may be linked to an advertisement marketing server and a delivery order server. In addition, the channel management system 225 may be linked to a push message server, so as to send a push message to a particular group or user.

The operation management portal 210 may comprise a system portal part 212 for managing an operating system, a platform portal part 214 for managing registration of goods and statistics, and a partner portal part 216 for providing access to users and enabling operation management.

The system portal part 212 is a portal for managing a core system and various back-end systems required for implementing the region-originating development platform of the present inventive concept, and may be implemented to be used for maintenance of the platform by a user. In an embodiment, the system portal part 212 may comprise various tools and sources for managing a prepaid system, and a MAP (mobile application platform) server for managing users and life cycles of services and for processing requests and pushes of the service application. The platform portal part 214 is a portal part for registering and managing goods or services to be used for regional services, and may be implemented to be accessible to developers or businesspeople. The partner portal part 216 is a portal for member stores owners to access thereto for retrieving and processing member store information, balance calculation, statistical data, etc., and may be provided as a web service to be accessible, as is the case with a web portal.

The voucher reload program 230 is a regional program to be provided to a staff-in-charge of a regional service, upon implementing a regional voucher service, and the information of a regional voucher recipient list may be uploaded for reloading through the voucher reload program without uploading to the service server 220. The voucher reload program 230 may comprise field items required for reloading a voucher, such as recipients, amounts to be provided, data, etc.

The reload transaction terminal 240 is a transaction terminal for receiving reload transactions requested via the voucher reload program 230 or the operation management portal and for creating transaction statements. The reload transaction terminal 240 may comprises, upon receiving information of a reload request, a function of generating a reload transaction statement, a function of adding an encrypted, valid authentication code to the reload transaction statement, a function of sending the statement, a function of a general payment, etc. In an embodiment, the reload transaction terminal 240 may be connected to the voucher reload program 230 through a local network, and thus, can generate a reload transaction statement for a reloading request, without connection to outside.

In this way, the region-originating development platform proposed by the present inventive concept is a core system for operating services, and may implement various regional services by utilizing the service server 220, and the operation management portal 210 as a back-end system for operating such services and goods, and partner management. Moreover, in case of voucher services which requires security, it is possible to include such local network construction as the voucher reload program 230 and the reload transaction terminal 240, and accordingly, to support generating transaction statements internally, without connecting to an external network. The voucher reloading service will be described in more detail with reference to FIGS. 6 and 7.

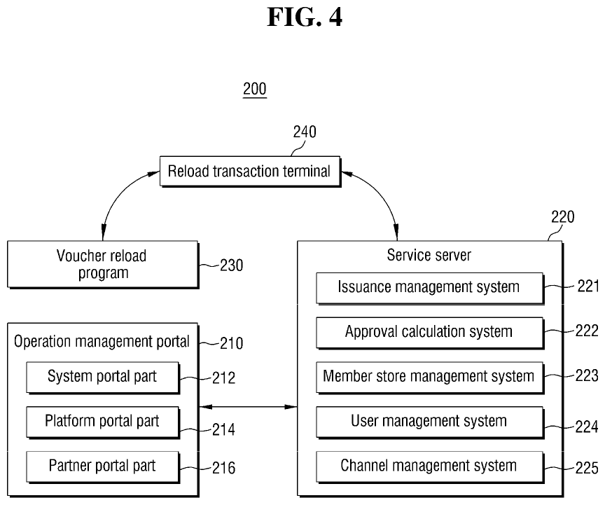

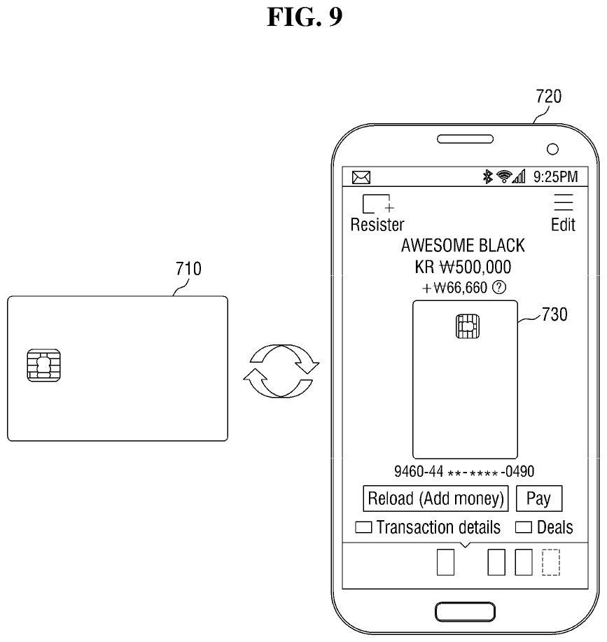

FIG. 5 is a block diagram illustrating a payment process of a system according to an embodiment of the present inventive concept. The region-originating development platform 200 may support to issue electronic gift certificates for revitalizing regional economies or other electronic gift certificates to be used, and may support to be payable by implementing an amount reloaded with a regional support voucher as a physical card or mobile card (for example, 710, 730 in FIG. 9).

In an embodiment, a user may user a physical card 110, for example an IC card, as a payment method. As descried above, the physical card 110 may be a card created from electronic gift certificates issued for revitalizing regional economies or other electronic gift certificates in a fixed monetary value or a reloadable form, or a prepaid electronic payment means (or a prepaid card) reloaded with an amount of a regional support voucher. Herein, a case where the physical card 110 is a physical card for regional payment usable only in specified regions (for example, specified administrative districts, or islands) will be mainly described. In addition, the physical card 110 of the present inventive concept may be linked to the mobile terminal 120, so as to facilitate such functions as registration, application for tax deduction, balance check, reloading, refund, balance transfer (gift), etc.

If a user pays through a member store terminal 450 at a member store 400 located within a region, then the member store terminal 450 sends an approval request message to an approval calculation system 222 of a service server 220 to make a transaction approval request. Though not shown in the drawing, the member store terminal 450 may also go through the VAN or other hosted services for transaction approval and purchase. The service server may receive a transaction approval request statement and may authorize an approval or rejection.

In an embodiment, the approval calculation system 222 comprises a transaction processing server for processing payment request information received from the member store terminal 450. The transaction processing server may be implemented with one or more servers for processing payments. For example, it may comprise a PP (payment processor) server for processing a transaction statement upon reception of payment request information, and an ITA (Issuer Token Adaptor) server for verification of cryptograms (or Message Authentication Codes (MAC)) and processing a PAN-token conversion request. In an embodiment, the ITA server may convert and store token values, in conjunction with the TSP (Token Service Provider) server which stores PAN values and token values. In addition, the transaction processing server may comprise an IAS (Issuer Authorization Switch) server for performing final approval and refund processes, and balance management. Additionally, it may comprise an RPG (Remote Payment Gateway) server for relaying transaction authentication and information, and a virtual VAN server for providing a transaction interface by providing a virtual VAN in case there is no VAN.

Upon reception of payment request information from the member store terminal 450, the transaction processing server may extract member store information and payment information included in the payment request information. The member store information may be a member store number, a member store ID (merchant ID), or a payment terminal ID. The payment information may comprise a payment amount, a payment date, a card token value, etc. The payment information may be entered and sent/received in such a manner of directly writing or selecting options out of displayed items through the member store terminal 450, and may set necessary item fields for respective payment cards in various ways according to a request from a member store or administrative settings.

In an embodiment, the transaction processing server may check region information that is mapped to a member store ID and stored, so as to check whether an electronic gift certificate (for example, a traditional market gift certificate, or an island gift certificate) used for payment is usable in that region to determine whether to approve or not. In another example, the transaction processing server may determine whether to approve without region information in case of an electronic gift certificate issued by the regional integration server 300 or general currency money.

Further, the approval calculation system 222 may comprise a calculation processing server. The calculation processing server may perform a calculation for payment details carried out at the member store 400. The calculation processing server may manage records of respective transactions, records of interested parties (for example, transaction records by member stores), and calculation records (payments to member stores, refunds, etc.). In an embodiment, the calculation processing server may be provided to retrieve transaction records, calculation records, etc. by member store owners through the operation management portal 210. In another embodiment, the calculation processing server may forward member store calculation information and statistics information to the member store management system 223, and may be implemented to make the member store management system 223 initiate through the operation management portal 210.

As such, in case of using the service server 220 of the present inventive concept, monetary notes, gift certificates, vouchers, support funds, etc. issued in a region or within particular markets or areas of the region, may be stored in a physical card 110 and a mobile card as a unified payment method, thereby providing an effect of maximizing convenience for users. Upon combining systems through the service server 220, it may be easy to accurately calculate balances and collect statistical data and to use them as materials for various regional economic analyses. The member stores or institutions may make use of the infrastructure of existing payment terminals, so as to save the cost to build a new business, as well as to provide an effect of boosting consumption within the region. It may be easy for the member stores to circulate their own gift certificates, points, etc., so as to enhance competitiveness of small businesses, and convenience of real transactions may be improved as payment methods can be unified.

The prepaid electronic payment means in the form of a mobile card operated by the mobile terminal of the present inventive concept and physical card 110 may be tax deductible according to relevant tax laws. For example, in the Republic of Korea, the prepaid electronic payment means has a higher percentage of tax deductibility compared with traditional credit cards, and accordingly, a user may enjoy more tax benefits. For instance, credit cards have a 15% of tax deduction rate for a total amount of payments, whereas debit cards, registered prepaid cards, electronic debit payment means, registered prepaid electronic payment means, registered electronic cash have a rate of 30% tax deduction, resulting in more tax deduction benefits.

FIG. 6 is a block diagram for describing a voucher reload process of a system according to an embodiment of the present inventive concept. This is a voucher reload process using an administrator reloading function, and voucher support funds offered in a region such as childbirth allowance, child support grant, youth allowance, etc. may be issued through the region-originating development platform 200, so as to support easy reloading and use. Since it is possible to implement to reload corporate credit cards issued to institution staff members through such an administrator reloading function, thereby making it possible to use it as business expenses of institutions. In case of supporting a prepaid corporate card for business-related expenses, it is possible to prevent overuse of the card because payment is allowed within the remaining balance which is an inherent nature of a prepaid card, and also possible to add various functions such as restrictions on businesses of the card usage, limits on maximum amounts to be used, etc. through the region-originating development platform 200. Since the physical card of the present inventive concept can be linked to the mobile card, a supervisor, for example, may hand out his corporate card to a team member for business expenses and to check the usage details through the mobile terminal 120

Previously, welfare vouchers or allowances have been provided through credit cards (for example, KB happy card in Korea) issued from authorized credit card companies. However, in this case, there is a problem in that some users cannot meet requirements for a credit card application, and accordingly, may have a hard time in getting a credit card. In addition, since there are fees to be paid to the credit card companies and the VAN, there is a drawback of an extra cost in addition to the allowances that are actually provided.

The voucher reload process of the present inventive concept is designed to solve such a problem, and is configured such that the physical card provided via the region-originating development platform may be reloadable with a voucher for payment, so that it is easier for a user to acquire a card, for regional institutions to save fees and to easily reload and calculate voucher balances.

The voucher reload process may be connected to a web service such as the operation management portal 210 as described with reference to FIG. 4, or may be carried out using the voucher reload program 230. Herein, a process using the voucher reload program 230 using a local network will be mainly described with reference to FIGS. 6 and 7.

The voucher reloading personnel (for example, a local government official) may receive the voucher reload program 230 through the region-originating development platform 22. The voucher reload program 230 is a software program to be installed and run in a computing device (for example, a PC) of the voucher reloading personnel, and may comprise a form file containing fields necessary for reload transactions. In an embodiment, the form file may comprise a name field of a recipient list, a reloading start date field, a reloading period field, a reloading amount field, etc. These fields may be automatically extracted and uploaded at the time of generation of a reload transaction statement at the reload transaction terminal 240. The voucher reloading personnel may directly enter field data to the voucher reload program 230, or may enter field data to retrieve a voucher recipient list from the stored database.

The reload transaction terminal 240 may receive the form file to which the field data have been entered from the voucher reload program. In this case, the reload transaction terminal 240 and the voucher reload program 230 may be located in institutions such as a local government office to use a local network, and may send/receive a list form file with a secured local network, without connecting to general external networks. For example, the reload transaction terminal 240 and the voucher reload program 230 may connected with wires or wirelessly each other through the local network.

In an embodiment, the reload transaction terminal 240 may comprise the SAM (secure application module). The SAM is a smart secure application module, and is installed inside the reload transaction terminal 240, to verify the validity of the terminal, to encrypt the transaction data for reloading so to prevent the leakage of information, and to authenticate and verify communication messages. It also stores electronic values transferred from a card. The SAM may be in the form of hardware such as the USIM, or may also be embedded in the form of software. The SAM may store an encrypted key for encrypting a message authentication code for a reload transaction statement.

The service server 220 may receive a reload transaction statement from the reload transaction terminal 240. The service server 240 verifies the validity of the reload transaction statement, and, in case of a valid reload transaction statement, extracts field data included in the transaction statement to proceed with a reload process. In an embodiment, the field data may include a token value corresponding to a card number. The service server 220 may be implemented to extract a card number and reloading amount data to be reloaded to the corresponding card number, followed by adding the amount of reloading money to that card number in the ledger server to update the balance data thereof. The region-originating development platform 200 of the present inventive concept implements to link the physical card 110 and the mobile terminal (mobile card) using a token value, and thus, has an effect of automatically reloading an amount of money to a physical card to be used by a user, without a separate synchronization procedure.

In case of implementing a voucher reload process, relevant regional cards may be automatically reloaded with support funds (allowances) at payment cycle without a user having to visit a government office in person, thereby greatly improving convenience for users. Moreover, there is an advantage for government offices or institutions that provide support funds to directly reload cards or to calculate and manage balances without going through various financial institutions or related companies, thereby facilitating management or statistical analyses and saving expenses spent on project implementations.

FIG. 7 is a flow diagram for describing the voucher reload process of the embodiment described with reference to FIG. 6. The present embodiment describes a method for performing the voucher reload process through the voucher reload program 230, reload transaction terminal 240, and service server 220; however, it is not limited thereto, and it may be implemented with a device or program into which the voucher reload program 230 and the reload transaction terminal 240 are integrated, or the voucher reloading may be carried out through the operation management portal 210 using a secured communications network.

First, the voucher reloading personnel may access the voucher reload program which is preinstalled (step 510). In this case, it may be implemented such that the voucher reloading personnel may have access to pre-authorized users only through an authentication procedure. For example, the voucher reload program may be accessed through various authentication methods such as biometric authentication, PIN authentication, password authentication, OTP (one-time password) authentication, certificate authentication, etc.

The voucher reloading personnel may enter voucher recipient list according to entry fields presented in the voucher reload program (step 520). As described above, the voucher reloading personnel may directly enter the voucher recipient list, or retrieve the voucher recipient list from a pre-stored database. Once the entry fields are filled out with field data, the voucher recipient list may be uploaded to the reload transaction terminal 240 connected to a local network (step 530). In an embodiment, it may be set such that the voucher recipient list may be automatically uploaded or synchronized in a preset period or date. In another embodiment, the voucher reloading personnel may also manually upload the voucher recipient list to the reload transaction terminal 240.

Once received the voucher recipient list, the reload transaction terminal 240 may use an encryption key which is acquired in advance to encrypt a message authentication code (MAC) (step 540). The reload transaction terminal 240 generates a reload transaction statement using the field data of the voucher recipient list, and then generates an encrypted reload transaction statement by attaching the encrypted message authentication code thereto (step 550). For such a message authentication code, it is not possible to interpret the transaction statement even if intercepted during the transmission, without the encryption key of the message authentication code, and even if the transaction statement was interpreted, because it only contains a token value rather than a real card number, there is no risk of the real card number and reloading information being leaked.

The reload transaction terminal 240 sends the generated reload transaction statement to the service server 220 (step 560). The service server 220 may use an encryption key held therein in advance to decrypt the message authentication code of the received reload transaction statement, so as to verify the validity thereof (step 570). In this case, the encryption keys (or algorithms) held by the service server 220 and the reload transaction terminal 240 may be the same encryption key. If the message authentication code is valid, the service server 220 performs reloading according to the reload transaction statement (step 580). In an embodiment, the service server 220 reloads an amount of money to the corresponding token value of the ledger server according to the data field in the reload transaction statement. In other words, the amount of money being reloaded is added to the remaining balance of that token value of the ledger server, so as to update and record the balance data. In an embodiment, the service server 220 may perform a real-time reloading or a scheduled reloading, according to reloading dates recorded in the data field.

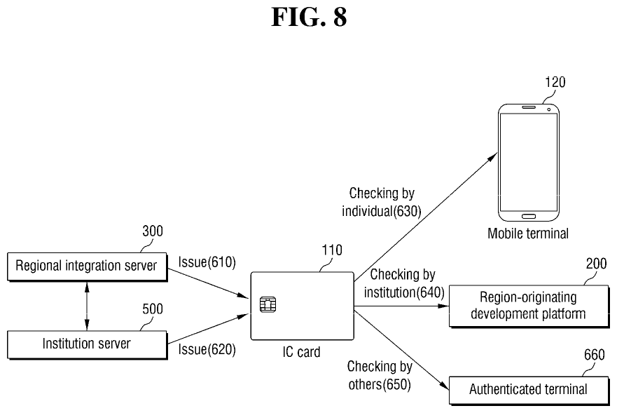

FIG. 8 is a block diagram for describing institution services of a system according to an embodiment of the present inventive concept. In addition to the member store payment service (see FIG. 5) and voucher reload service (see FIGS. 6 and 7), various services provided by regional institutions are supported in conjunction with the region-originating development platform 200.

As a first embodiment for institution services, an (ID) identification service such as a student ID card may be provided. Upon an issuance request from institutions such as schools or Education Office or other regional government offices (for example, a city hall or provincial government office), an ID card may be issued as a mobile card or a physical card that can be displayed on the mobile terminal 120 or the physical card. In an embodiment, if the institution server 500 or the regional integration server 300 makes a request for an ID card issuance to the issuance management system 221 of the region-originating development platform 200, the region-originating development platform 200 may create accounts for applicants of the request information, or may proceed with issuance of ID cards for existing accounts. For example, an ID card may be issued in such a way of matching and storing a token value of the ID card with a user's ID, a resident registration number or telephone number. In this case, it may be implemented to embed an applet for access authorization into a physical card 110 along with identity information when issuing the ID card. In an embodiment, a mobile ID card may be implemented to be directly sent to the applicant's mobile terminal 120 to be outputtable, or the physical card 110 may be shipped separately or through institutions.

The ID card issued through such a region-originating development platform 200 may be checked out by an individual through the mobile terminal 120 (630), or may also be checked out by an institution (such as a school) through an operation portal of the region-originating development platform 200 (640). Furthermore, it may be implemented to enable identity check and verification additionally through an authenticated terminal 660 at such institutions as government offices, police department, hospitals, etc. (650). For example, the ID card may be implemented in a two-dimensional code such as a barcode or QR code, may be applied with a separate security technology such as a three-dimensional barcode, etc., or may be implemented to check it out through code scanning by a terminal, or to read the ID card information through NFC. In an embodiment, the ID card may be added with an anti-photographing function with the mobile terminal 120 to make it impossible to take photos, capture images or forge it, or the physical card may be added with a hologram or an authentication code thereto.

In case of issuing an ID card through the region-originating development platform 200, the physical card 110 issued as the ID card may integrate the reloading and payment functions therein, and accordingly, it is possible to use a combination of the member store payment function and the voucher reloading function as described above with reference to FIGS. 5 to 7. In case of implementing such a service, a residential user may use a single physical card 110 for various purposes such as ID card and payment purposes, thereby providing an effect of improving practicality and convenience.

In a further embodiment, in case of the physical card being a card comprising a display, it is possible to output various codes in a barcode or QR code, and thus, it may be used for two or more ID cards or may also be used as a multi-payment card by containing multiple payment applets.

As a second embodiment for institution services, a medical service may be provided to make it possible to record and check personal health information. In an embodiment, a user may present a physical card 110 or a service application of a mobile terminal 120 at a medical center such as hospitals, or clinics, so as to record visits to medical institutions or medical treatments. For example, it may be implemented to record medical treatment and prescription information, etc. on the physical card 110 through a medical treatment recording device at a medical institution server 620 after the treatment. It may also be implemented to transmit encrypted health information from the medical institution server 620 to the mobile terminal 120, and to store it in the region-originating development platform 200 in an encrypted form.

With continuous recording of such medical information, an individual may check it through the mobile terminal 120 (630), or medical institutions may check it out through the institution server 500 or at the region-originating development platform 200. Alternatively, it may be implemented such that health information may be checked through the authenticated terminal 660 (such as a checkup terminal of paramedics) in an emergency situation (650).

In case of providing medical services using the region-originating development platform 200 as described above, it may resolve inconvenience that previously a user could not easily check his or her own health information, etc. and thus, had to individually visit a medical institution. Moreover, it is possible to check health information through a mobile card or a physical card carried by a user in an emergency situation, thereby enabling a quick treatment and emergency aid.

As a third embodiment for the institution services, the region-originating development platform 200 may further support a marketing and order service for connecting regional member stores. The region-originating development platform 200 may be implemented to provide customized information useful to a user through a service application installed on the user terminal 120 of the user. In this case, it may be implemented to send out advertisements and promotions, marketing information, or messages whenever the user opens the service application, and to send out coupons and discount information in the form of push messages. Such a marketing service supports the regional member stores to perform marketing in low cost and easy way. Such a marketing and order service may help small businesses increase sales and develop distribution channels within the region. Small businesses are particularly small in size among small to medium-sized enterprises for operating a business to make a living as self-ownerships or craftsmen, and may have difficulty in developing markets and distribution in many cases. In case of utilizing the region-originating development platform 200 of the present inventive concept, it may support manufactures (small manufacturers) who lacks decent sales channels to help find markets, and may provide sellers (businesses) with offline and online order channels, so as to help them increase sales. In an embodiment, the region-originating development platform 200 may classify and send out marketing information based on locations. For example, a location-based service may be implemented such that in block A, advertisements of the member stores located around block A may be sent out, and in block B, advertisements of the member stores located around block B may be sent out. The region-originating development platform 200 may classify and send out marketing information by time, and may output marketing information customized by ages and genders. In a further embodiment, it may be implemented to output marketing information customized to individuals by learning payment information of users, and statistics of order information.

Further, the region-originating development platform may support the order service as a means to enhance competitiveness of member stores. Regional member stores may be classified by business types and areas, detailed information (for example, business hours, menu information, phone numbers, etc.) of the member stores may be provided, and it may support to be connectable to member stores through a direct phone connection from a use by providing a direct phone connection service. In a further embodiment, by linking to a delivery order application or external delivery order server, it may be implemented to enable a mobile order to member stores. Such an order service has an effect of saving an excessive delivery charge, leading to promoting member stores and, directly, increasing sales.

In another embodiment, the mobile card provided to the mobile terminal 120 may be used as a mobile ticket. For example, at a regional performance or event, a user may purchase a mobile ticket through the service application or a related web page, and may output the mobile ticket purchased on the service application, to use it as an admission ticket for the event.

In a further embodiment, the region-originating development platform may expand its service into a regional mobile market (a shopping mall, a sharing economy function, and so on) beyond marketing channels. In an embodiment, it is possible to support functions of exhibiting and selling, so as to promote merchandises of small businesses that run a manufacturing business to consumers (users) in a simple and accessible way. For another example, it may support for member stores or individuals to share, exchange, or sell various tangible or intangible assets through regional mobile markets. For example, a regional mobile market service may provide a platform enabling trades of various goods and services such as trades or rentals of general products as well as used products, requests for instruction or lectures, real estate deals, talent donation, etc. Further, the region-originating development platform 200 may support a point conversion function capable of collecting points and mileages on the markets into the card of a user, and provide a function to use, give as a gift, or donate the points based on the user's convenience. However, since it is designed such that marketing through coupons or points and refunds using points are not possible, the service may be designed so as to prevent illegally cashing points or mileages.

In this way, the region-originating development platform 200 of the present inventive concept has an advantage of an unlimited expandability of services through connection to various regional member stores, individuals, or institutions. While implementing various services, the mobile terminal and physical card are supported as a single platform and a unified means, resulting in an integraion and connection of regional services.

FIG. 9 is an exemplary drawing for illustrating a synchronized operation between a user terminal and a physical card according to an embodiment of the present inventive concept. On implementing the services of the region-originating development platform of the present inventive concept, a user may link and operate a physical card 710 with a mobile card 730 of a mobile terminal 710.

In an embodiment, through account registration or joining a membership, and ID authentication, phone number authentication procedures, etc., a user may first create an account and register the physical card 710 in a service application. In an embodiment, the physical card 710 may be registered to the mobile terminal 720 by tagging the physical card 710 thereto. Tagging herein indicates connection between the mobile card and physical card by using a short-range wireless communication technology such as NFC and BLE. In another embodiment, the physical card may be registered by taking a photo of a code (for example, a barcode or QR code) shown on the physical card 710 with the user terminal and recognizing a token value of the physical card 710.

The mobile terminal 720 when requesting a registration of the physical card, sends a request message for setting the physical card to the service server 220. In an embodiment, the request message may comprise a token value (for example, 7777 77777777 0001) of the physical card, and an ID (or other identification information) of the mobile card 730 (for example, an HCE card) to be mapped to the physical card. Optionally, physical card setting information may comprise various setting information such as a period (time) for mapping a particular HCE, or other card mapping scheduling according to time slots.

The service server 220 may forward the token value of the physical card 710 to a token service provider. The token service provider may receive the token value of the physical card 710 and information about the mobile card 730 to be mapped, and may store the token value of the physical card 710 and at the same time may extract and store PAN information of the mobile card 730 to be mapped. The database of the token service provider may map the token value of the physical card and the token value of the mobile card to the same PAN value to store them, and thus, may make it possible to link and use the physical card 710 and the mobile card 730, without a separate synchronization process.

In this way, according to the linking between the physical card and mobile card of the present inventive concept, even if a payment request is received from a payment means having a different token value, processing is carried out based on the same PAN value, and accordingly, it is possible to process the transaction as a single card. In other words, even when a card is used with different payment means, the service server 220 may recognize them as the same card so to manage the balance thereof without a separate synchronization process, thereby providing an effect of improving user convenience.

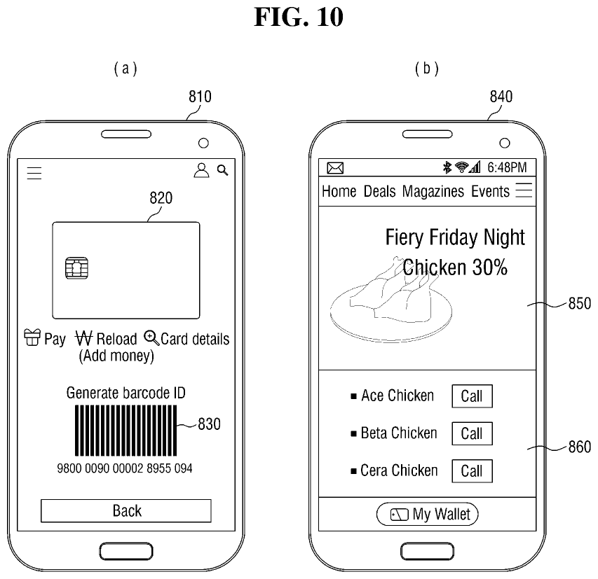

FIG. 10 is an exemplary drawing for describing an ID function, an advertisement function, and an order function of a user terminal according to another embodiment of the present inventive concept. As described with reference to FIG. 8, the region-originating development platform of the present inventive concept may provide services in conjunction with various institutions.

In an embodiment, as shown in FIG. 10 (a), an ID function may be provided. The service application running on a mobile terminal 810 of a user may comprise a mobile card image 820 for payment and a barcode image 830 for ID. In an embodiment, the physical card may be implemented as a single physical card with a payment card 820 and an ID card 830 integrated therein, having an IC chip stored with a payment applet arranged on the front face of the physical card and a barcode printed on the rear face of the physical card. Though the drawing shows an example where an ID card is implemented in the form of a barcode, the ID card is not limited thereto, and may be directly printed with information such as a photograph and an ID number, an issuing authority, an issue date, etc., or may be implemented in the form of a thumbnail or a QR code. Moreover, the ID card may implement not only ID information for identity verification, but also access authorization function by storing an access applet in the physical card 110.

In a further embodiment, as shown in FIG. 10 (b), marketing and order services may be implemented for regional member stores. The service application may comprise various marketing information such as deals, events, and so on, and may be used as a promotional tool of the regional member stores. For example, as shown in FIG. 10 (b), it may comprise an advertisement area 850 for displaying deals or events and also, an order area 860 for making a phone call to order from regional member stores. Though the present embodiment only shows call buttons to make a phone call to regional member stores, it is not limited thereto, but may further display detailed information (such as business hours, or menu information) about the regional member stores, and may be implemented to enable, in addition to the call buttons in the service application, an order notification or cancellation, etc. by linking to other delivery order applications or linking to the POS machine of delivery stores and to the mobile terminal of the member store owner.

As such, the regional service application supported by the region-originating development platform 200 may provide various regional services to users and may be used as a promotional and marketing tool for the regional member stores.

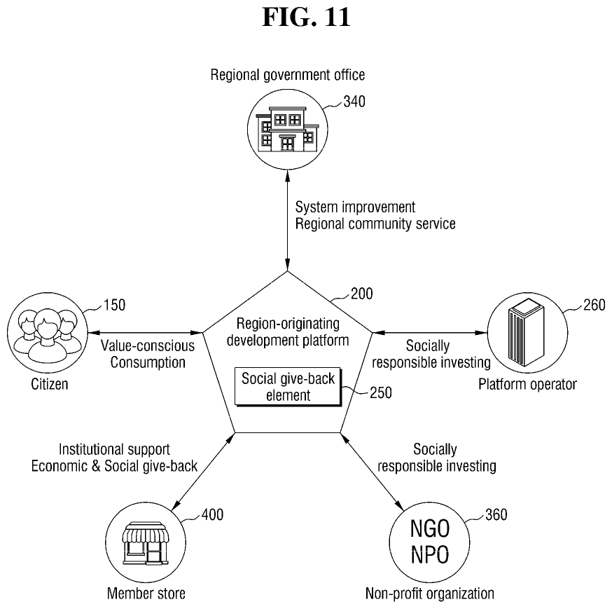

FIG. 11 is a drawing for describing social responsibilities and a virtuous cycle structure of a regional community of a system of the present inventive concept. According to the system of the present inventive concept, with the region-originating development platform 200, a structure of a virtuous circle of economic and social values for a regional community may be derived, and a socially responsible investing structure according ISO 26000 (guidance on social responsibility) may be implemented.

The region-originating development platform 200 may comprise a social give-back element 250 for giving tangible or intangible values offered from various entities back to society, and may implement a community contribution structure in conjunction with national or regional government offices 340 of a “city” or “district” level, citizens 150, regional member stores 400, non-profit organizations such as NGOs, a platform operator 260, etc. In an embodiment, the social give-back element 250 may be tangible assets in the form of funds or cloud funds or their operating entities, and may comprise intangible assets such as volunteer work, public arts, and talent donations or their operating entities. The present embodiment will be described with an example where the social give-back element 250 is a “fund” for a virtuous circle of investment.

In an embodiment, citizens 150 as users of the physical card 110 or mobile terminal 120 provided by the region-originating development platform 200 may receive voucher support funds through the region-originating development platform 200 based on the welfare service of a regional government office 340. Alternatively, citizens 150 may reload their payment means 110, 120 by themselves to use in the community. For example, a citizen 150 may make a payment at a regional member store 400 through the region-originating development platform 200. In this case, the citizen 150 purchases goods or services from a member store 400 operated by a social enterprise or a community cooperative, which may be considered as value-conscious consumption that helps contribute to local economies and society. For another example, a user may donate points that have accumulated through purchases (for example, 10% cash back on purchases) within the region to the social give-back element 250, which may also be considered as value-conscious consumption. Here, value-conscious consumption may be extendedly construed as a concept of investing by a “good consumer” to a “good entrepreneur” (ISO 26000), which goes beyond and above just a one-time consumption to consumption activities involving broad usefulness.

The regional member stores 400 may also generate and increase profits thanks to the citizens 150 or institutions through the region-originating development platform 200, and may either donate part of the profits back to the social give-back elements 250 or invest in another way. In other words, member stores 400 may be benefited directly or indirectly from the community by increasing their profits owing to the region-originating development platform 200 supported financially and institutionally by the regional government office 340, and may realize value-conscious consumption back to the social give-back element 250 by paying fees for the platform used or making a donation for the profits they make.

On the other hand, the platform operator 260 or non-profit organization 360 may make a social responsibility investment in relation to the social give-back element 250. In implementing a voluntary virtuous circle structure of regional economic activities and social expenses, various institutions within a region such as non-profit organization 360, platform operator 260, etc. and individuals may voluntarily invest in companies with social responsibility, according to the guidance on social responsibility of ISO-26000 which requires efforts to help their communities, so as to participate in contribution to society.

The regional-originating development platform 200 may use the service application, operation management portal 210, etc. as a medium to implement the social give-back element 250, it may be implemented such that various social participants such as citizens 150, member stores 400, non-profit organizations 360, operators 260, etc. within the region can check the status, transaction records, etc. of the social give-back element 250. In an embodiment, it may be implemented such that the region-originating development platform is accessible only when authentication is verified according to predefined criteria. In addition, the social give-back element 250 may be operated on the regional-originating development platform 200 and may be one of the elements operated by the regional integration server, and may be implemented as one or more social give-back elements for respective basic-level or municipal government offices. Moreover, the social give-back element may be implemented to re-distribute or invest tangible and intangible assets according to the criteria designed by the regional integration server 300, base centers 310 to 330, or the autonomous centers 314 to 336.

According to the regional community system using such a regional-originating development platform 200, it is possible to create give-back and circulation of economic and social values based on value-conscious consumption and socially responsible investments, thereby providing an effect of achieving greater good for entire regional community. In addition, it may also contribute to the development of regional community by enhancing social order and community spirit through active distribution and revitalization of such tangible and intangible assets.

Though the present inventive concept has been described with reference to the embodiments shown in the drawings, such embodiments are merely exemplary, and a person having ordinary skill in the art will understand that various changes or other equivalent embodiments can be made therefrom. Therefore, the true protective scope of present inventive concept is defined by the principles and spirit of the accompanying claims.

1. A system for operating a region-originating development platform, comprising:
a service server for coordinating a regional service between a physical card and a mobile terminal of a user, one or more regional member stores, and a regional integration server, the service server comprising an issuance management system for sending mobile card information to the mobile terminal, and an approval calculation system for processing an approval for a transaction approval request from the local member stores;
a portal server for operating one or more portal services running on the service server, the portal server comprising a system portal part used to operate a system within the service server, a platform portal part for managing one or more merchandises offered as the regional service, and a partner portal part for managing partners including the member stores;
a regional integration server for operating a regional service in a predefined metropolitan area;
one or more base center servers, connected to the regional integration server at a lower level in a layered structure, for operating one or more common regional services in conjunction with the regional integration server; and
a social give-back element operating server linked to the regional integration server or the one or more base center servers, for operating a regional value-conscious consumption service through the portal server, and for collecting and managing data of tangible and intangible assets given back in accordance with predetermined criteria,
wherein the mobile card information is issued in a form of a token value corresponding to primary account number (PAN) information in response to a card issuance request made according to a request from the mobile terminal, the regional integration server, or the base center servers, and is sent to the mobile terminal by the issuance management system,
wherein the base center server is a server for operating a regional service in a specified administrative district included in the metropolitan area, operates the common regional service with the regional integration server, or modifies some conditions of a regional combined service designed by the regional integration server, and designs and operates a customized base center service,
wherein the mobile card information comprises an electronic gift certificate requested by the regional integration server or the base center servers,
wherein the common regional service and the customized base center service comprise issuance, calculation, and management of the electronic gift certificate,
wherein the regional integration server issues an electronic gift certificate in the form of the mobile card information, and assigns an individual ID code for each merchandise to a regional combined electronic gift certificate or a base center electronic gift certificate issued to a corresponding base center in response to a request from the base center server,
wherein the individual ID code is assigned to correspond with the specified administrative district or a specified region covered by the base center servers,
wherein if monetary units or values of the regional combined electronic gift certificate and the base center electronic gift certificate are different from each other, a remaining balance of the electronic gift certificates can be cashed or combined, based on a predetermined exchange algorithm,
wherein the approval calculation system extracts member store information and payment information included in payment request information received upon a transaction approval request from the regional member store, and approves the transaction if member store region information included in the member store information matches region information based on the individual ID code, and
wherein the social give-back element operating server, when collecting data of tangible assets, collects accumulated points or fees based on a consumption record of the user or the one or more regional member stores using the common regional service or customized base center service, or collects give-back assets in a form of voluntary donations.

2. The system of claim 1, wherein the physical card has a physical card token value different from the mobile card information; and
the service server matches the mobile card information and the physical card token value with one piece of PAN information and stores them.

3. The system of claim 2, wherein the mobile card information is designed as a regional mobile card usable only in a specified region; and
the service server, at a time of payment with the regional mobile card or the physical card having the same PAN information as the regional mobile card, determines whether to approve the payment based on balance information and region information in the service server.

4. The system of claim 2, wherein the service server, when issuing the mobile card information, matches the regional member store with one or more pieces of merchandise information and stores them, and at payment for the merchandise, determines whether to approve the payment or not based on the merchandise information and the member store information.

5. The system of claim 1, further comprising:
a recording medium on which a voucher reload program capable of entering a list to be reloaded for reloading a voucher is recorded; and
a reload transaction terminal connected to the voucher reload program via a network, for receiving the list to be reloaded.

6. The system of claim 5, wherein the network is a local area network (LAN) that can be connected only in a specified building or space, by blocking connection from external networks in a wide area network.

7. The system of claim 5, wherein the reload transaction terminal comprises a security authentication module (SAM) for storing an encryption key; and
the security authentication module encrypts a message authentication code using the encryption key.

8. The system of claim 2, wherein the service server issues an ID card to the mobile terminal or the physical card, in response to a request from the regional integration server or the base center server; and
the ID card comprises identity information and access authorization information.

9. The system of claim 2, wherein, on the mobile terminal or the physical card of the user, personal information including health information can be recorded through an institution server; and
recorded personal information can be checked via an authenticated terminal.

10. The system of claim 2, wherein an output screen of a service application running on the mobile terminal comprises an advertisement area and a member store information area; and
the member store information area comprises a contact section for making a phone call, or an order information send section for sending transaction information or cancellation information to a member store terminal.

11. The system of claim 2, wherein the regional integration server comprises a combined service design unit for storing design information of the regional service, an electronic gift certificate management unit for storing electronic gift certificate information including types and issue information of an electronic gift certificate usable in the region, and a base center management unit for managing one or more base centers; and
the base center servers, in conjunction with the regional integration server, operate a base center electronic gift certificate created by redesigning the customized base center service by adding, deleting, or modifying some conditions to/from/of the regional combined service designed by the regional integration server.

12. A method for operating a region-originating development platform, by a service server which coordinates a regional service between a physical card and a mobile terminal of a user, one or more regional member stores, and a regional integration server, the method comprising;
issuing a card by the service server, wherein card information corresponding to primary account number (PAN) information of a card is issued in a form of a token value in response to a card issuance request by the mobile terminal, the regional integration server, or the base center server, the card information comprises an electronic gift certificate, a regional combined electronic gift certificate is issued upon a card issuance request by the regional integration server, and a base center electronic gift certificate is issued upon a card issuance request by the base center server;
by the service server, assigning an individual ID code for each merchandise to the regional combined electronic gift certificate or the base center electronic gift certificate issued in the issuing a card, the individual ID code being assigned to correspond with a specified administrative district or specified region;
approving a transaction by an approval calculation system of the service server if member store region information included in member store information matches with region information based on the individual ID code, after extracting payment information and the member store information included in a payment approval request received upon a transaction approval request from the regional member store;
giving back by sending donations, fees, or points as give-back assets based on consumption records of the one or more regional member stores or the user using a common regional service or a customized base center service to a social give-back element operating server, wherein the social give-back element operating server operates a regional value-conscious consumption service through a portal server and collects and manages data of tangible and intangible assets given back according to predetermined criteria, in conjunction with at least one server out of the service server, the regional integration server, and the one or more base center servers; and
cashing or combining remaining balances of the electronic gift certificates by the service server, according to a predetermined exchange algorithm, if monetary units or values of the regional combined electronic gift certificate and the base center electronic gift certificate are different from each other;
wherein the portal server is a device for operating one or more portal services running on the service server, and comprises a system portal part used to operate a system within the regional integration server, a platform portal part for managing one or more merchandises offered as the regional service, and a partner portal part for managing partners including the member stores, and
wherein the base center server is a server for operating a regional service of a specified administrative district included in a metropolitan area where the regional integration server runs a regional service, operates the common regional service with the regional integration server, or modifies some conditions of a regional combined service designed by the regional integration server, and designs and operates a customized base center service.

13. The method of claim 12, further comprising:
issuing the physical card, based on a request from at one of the mobile terminal of the user, the regional integration server, and the base center server; and
linking the mobile card to the physical card, by matching and storing a token value of the physical card with the PAN information after issuing the physical card.

14. The method of claim 13, wherein mobile card information for the mobile card is designed as a regional mobile card usable only in a specified region,
the method further comprising:
determining, by the service server, whether to approve a payment based on balance information and region information in the service server, at a time of the payment with the regional mobile card or the physical card having the same PAN information as the regional mobile card.

15. The method of claim 12, further comprising:
after the issuing a card, reloading a voucher by the service server, by receiving a reload transaction request including a reload transaction statement generated based on a list to be reloaded entered through a voucher reload program recording medium for reloading the voucher, from a reload transaction terminal,
wherein the reload transaction statement is generated by a reload transaction terminal connected to the voucher reload program recording medium through a local network; and
wherein the local network is a local area network (LAN) that can be connected only in a specified building or space, by blocking connection from external networks in a wide area network.

16. The method of claim 15, wherein the reload transaction terminal comprises a security authentication module (SAM) for storing an encryption key; and
the security authentication module encrypts a message authentication code using the encryption key.

17. The method of claim 13, wherein the issuing a card issues an ID card to the mobile terminal or the physical card, in response to a request from the regional integration server; and
the ID card comprises identity information and access authorization information.

18. The method of claim 13, the method comprising:
after the issuing a card, recording personal information including health information on the mobile terminal or the physical card of the user, through the service server or an institution server; and
checking recorded personal information through the service server or an authenticated terminal.

19. The method of claim 13, further comprising:
providing an output screen such that the output screen of a service application running on the mobile terminal comprises an advertisement area and a member store information area,
wherein the member store information area comprises a contact section for making a phone call, or an order information send section for sending transaction information or cancellation information to a member store terminal.

20. The method of claim 13, further comprising:
by the regional integration server, storing design information of the regional service and electronic gift certificate information including types and issue information of an electronic gift certificate usable in the region, requesting to the service server for issuing the electronic gift certificate based on the electronic gift certificate information;
designing a base center electronic gift certificate by the base center server, based on the electronic gift certificate information provided by the regional integration server, and redesigning the base center electronic gift certificate by adding thereto an additional condition provided by a base center service design part; and
issuing the base center electronic gift certificate by the service server in response to a request from the base center server.
